(19) United States
(12) Patent Application Publication
(10) Pub. No.: US 2004/0258359 A1
(43) Pub. Date: Dec. 23, 2004

(54) Low-loss optical connector

(76) Inventors: Paul B. Corkum, Gloucester (CA); David M. Rayner, Ottawa (CA); V. Ravi Bhardwaj, Ottawa (CA); Orson L. Bourne, Orleans (CA); Rod Taylor, Gloucester (CA); Cyril Hnatovsky, Ottawa (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/826,312

(22) Filed: Apr. 19, 2004

Related U.S. Application Data
(60) Provisional application No. 60/463,321, filed on Apr. 17, 2003.

(51) Int. Cl. G02B 6/26

(52) U.S. Cl. 385/39; 385/14

(57) ABSTRACT

A method of making connections between arrays of optical components such as waveguides, fibers and diode lasers, by linking them with optical waveguides written directly in three-dimensional blocks or wafers of a transparent dielectric material such as glass. If arrays are to be connected, any element can be connected to any other element, providing the flexibility to make cross-connects. In a particular embodiment, femtosecond laser dielectric modification is employed to manufacture the optical connector.

### CROSS-REFERENCE TO RELATED APPLICATIONS

This application claims the benefit of priority from U.S. Provisional Application No. 60/463,321, filed Apr. 17, 2003, the contents of which are incorporated herein by reference.

### FIELD OF THE INVENTION

The present invention relates generally to optical connectors. More particularly, the present invention relates to a low-loss optical connector that permits the alignment and connection of discrete optical components and arrays, such as waveguides, fibers and diode lasers, to other discrete components and arrays, and a method of fabrication of such a connector.

### BACKGROUND OF THE INVENTION

Improved optical packaging is important for the continued success of photonic applications in the telecom sector. Recently, there has been a move to Dense Wavelength Division Multiplexing (DWDM) technology to meet the demand for increased bandwidth for the Internet. The next phase in Internet development will likely focus on bringing large bandwidth direct to the home. The modest charge that a homeowner can afford for such bandwidth imposes severe restrictions on the cost of any “last mile” system, including its components and how the components are optically connected, or wired, to each other.

When connecting optical components, such as lasers, waveguides and fibers, and arrays thereof, it is important that the components be precisely aligned to prevent transmission losses at the connection, and, in some cases, to preserve a high degree of polarization. In order to properly align the optical components, sub-micron accuracy in three-dimensions is required.

Numerous manners of aligning and interconnecting optical components have been used to date. One broad class of connectors uses plugs in one waveguide array to connect to sockets in a second array. Such a connector is described, for example, in U.S. Pat. No. 5,511,138 issued on Apr. 23, 1996 to Lebby et al. In order to obtain sufficient alignment accuracy, precision manufacturing that is sensitive to variations in fiber diameter and core offset is required. However, even with microfabrication, it is difficult to fabricate plugs and sockets with sub-micron accuracy to precisely position each pair of waveguides to provide a low-loss connection. This is especially true for large arrays of waveguides.

Another common solution for connecting arrays of waveguides, fibers and lasers to fibers uses a discrete connector having V-grooves microfabricated into a silicon substrate. The connecting fibers are held in the V-grooves such that their ends abut. Such a solution is described, for example, in U.S. Pat. No. 4,818,058, issued Apr. 4, 1989 to Bonanni. V-groove fabrication tolerances are very small and the alignment is susceptible to variations in fiber diameter, core offset and to the effects of contamination in the V-grooves. The interconnection of a large number of optical components can produce significant stitching error, i.e. accumulation of small errors in waveguide location leading to poor overall array alignment.

Presently-employed connectors typically require labor intensive installation, often by hand, and do not lend themselves easily to automation, particularly when connecting large arrays. There is therefore a need for inexpensive technology to optically connect optical and photonic devices such as diode laser arrays, DWDM waveguide arrays and fiber arrays. Low cost can be achieved from automation and high product throughput. It is, therefore, desirable to provide an improved manner of aligning and connecting optical components and for fabricating connectors used in such a solution.

### SUMMARY OF THE INVENTION

It is an object of the present invention to obviate or mitigate at least one disadvantage of previous optical component alignment and connection arrangements, as well as manufacturing methods used in relation to such arrangements.

Generally, the present invention provides a method of making connections between arrays of optical components such as waveguides, fibers and diode lasers, by linking them with optical waveguides written directly in three-dimensional blocks or wafers of a transparent dielectric material such as glass. If arrays are to be connected, any element can be connected to any other element, providing the flexibility to make cross-connects. In a particular embodiment, femtosecond laser dielectric modification is employed to realize the connections. An optical connector and an apparatus for making the connector are also provided.

In a first aspect, the present invention provides an optical connector for connecting an input optical component to an output optical component. The connector comprises a three-dimensional optically-transmissive bulk dielectric for abutment with an input connection face of the input optical component and an output connection face of the output optical component. A connection path is written within the three-dimensional bulk dielectric for connecting the input connection face to the output connection face. The optical connector is ideally suited for connecting arrays of optical components, in which case, a connection path is written within the dielectric for each set of corresponding discrete optical components. Multiple optical connectors can be stacked together to provide a stacked connector assembly.

In presently preferred embodiments, the three-dimensional bulk dielectric is a glass block and the connection path is a waveguide written within the block by localized modification of the refractive index of the bulk dielectric, through, for example, femtosecond laser dielectric modification. The connection path can be straight through or bent. Waveguides can be profiled, such as by widening at certain points, to minimize transmission losses at a bend, or to minimize transmission losses at the input and output connection faces. Bent waveguides can take numerous forms, such as bent waveguides, substantially orthogonal waveguides disposed within the bulk dielectric to permit total internal reflection from one of the two waveguides to the other, or substantially orthogonal waveguides interconnected by a photonic crystal structure.

In a further aspect, the present invention provides a method of manufacturing an optical connector for connecting a first optical component to a second optical component. The method comprises locating a first optical connection point, for connection to the first optical component, on a first surface of a three-dimensional optically-transmissive bulk dielectric workpiece; and writing a connection path within the workpiece from the first optical component connection point to a second optical component connection point, for connection to the second optical component, on a second surface of the workpiece.

In presently preferred embodiments, the step of locating includes imaging the first optical connection point at an imaging detector, such as by detecting an image of maximum brightness and focus at the imaging detector. The step of writing includes selectively modifying the refractive index of the workpiece in three dimensions, and can include translating the workpiece relative to a writing means. Preferably, the method uses femtosecond laser dielectric modification. Multiple connection paths can be written within the same workpiece.

In a third aspect, the present invention provides an apparatus for manufacturing an optical connector for connecting a first optical component to a second optical component. The apparatus comprises means for locating a first optical connection point, for connection to the first optical component, on a surface of a three-dimensional optically-transmissive bulk dielectric workpiece; and a laser system for modifying the workpiece in three-dimensions. The laser system is capable of writing an optical connection path within the workpiece for connecting the first optical connection point to a second optical connection point on a second surface of the workpiece.

In preferred embodiments, the means for locating includes an imaging system for detecting an image of the first optical connection point, and the laser system is a femtosecond laser dielectric modification system. To permit operation in a transverse mode, two orthogonal imaging systems can be used.

In a fourth aspect, the present invention provides a customizable optical circuit. This “optical ASIC” comprises a plurality of optical components mounted on a wafer; and a plurality of selectively activatable connection paths for selectively connecting the optical components to provide a customized optical function. In a presently preferred embodiment, the plurality of selectively activatable connection paths are written within three-dimensional optically-transmissive bulk dielectric blocks abutting connection faces of the plurality of optical components.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 illustrates a first embodiment of a system used to perform a method of manufacturing an optical connector according to the present invention;

FIG. 2 illustrates a second embodiment of a system used to perform a method of manufacturing a an optical connector according to the present invention;

FIG. 3 illustrates a third embodiment of a system used to perform a method of manufacturing an optical connector according to the present invention;

FIG. 4 illustrates a system used to locate a workpiece with respect to a machining laser focus according to the present invention;

FIG. 5 illustrates an example of a method of writing bent waveguides in a transverse mode using a tailored focus in a connector according to the present invention;

FIG. 6 illustrates an example of a method of writing bent waveguides in a longitudinal mode by rotating the workpiece, in a connector according to the present invention;

FIG. 7 illustrates a fourth embodiment of a system used to perform a method of manufacturing an optical connector according to the present invention;

FIG. 8 illustrates waveguides bent through 90° using internal reflection in a connector according to the present invention;

FIG. 9 illustrates assisting transfer between orthogonal waveguides using photonic crystal structures in a connector according to the present invention;

FIG. 10 illustrates connecting waveguide arrays attached to orthogonal faces of a single dielectric block in a connector according to the present invention;

FIG. 11 illustrates stacked slabs of femtosecond laser-written waveguides connecting waveguide arrays in a connector according to the present invention;

FIG. 12 illustrates orthogonal waveguides within a prism according to a connector of the present invention;

FIG. 13 illustrates a fixed/fixed configuration of a connector according to the present invention with two precision dimension blocks; and

FIG. 14 illustrates a connector according to the present invention using photonic crystal structures.

### DETAILED DESCRIPTION

Generally, the present invention provides an optical connector for the connection of optical components, and arrays thereof. The optical connector is manufactured of a transparent or otherwise optically-transmissive material and provides optical wiring between optical components to be connected. The optical connector is essentially a three dimensional waveguide circuit that is written directly in three-dimensional (3-D) blocks or wafers with sub-micron precision. A presently preferred method of manufacture of such optical connectors uses Femtosecond Laser Dielectric Modification (FLDM) to modify the refractive index of a bulk dielectric material on a micron scale with micron precision in three dimensions. The present invention applies to any three-dimensional optical circuit, and can provide a customizable optical circuit in the optical space, similar to an ASIC in the electrical space. Such an “optical ASIC” has a plurality of optical elements, and a plurality of selectively activatable connection paths, employing optical connectors according to the present invention, for connecting the optical elements to each other to provide a customized optical function.

Although embodiments of the present invention will be described herein primarily with respect to the interconnection of arrays of optical components, it is to be understood that embodiments of the present invention are equally as applicable to the interconnection of discrete optical components. The optical components can be manufactured by any known technique.

The present invention also provides a general method of making connections between arrays of optical components such as waveguides, fibers and diode lasers by linking them with optical waveguides written directly in 3-D blocks or wafers of transparent dielectric materials such as glass to provide the necessary connection paths. If arrays are to be connected, any element can be connected to any other, providing the flexibility to make cross-connects.

The waveguides can be written by any technique capable of modifying the refractive index of dielectric materials on a micron scale and with micron precision in three dimensions, such as through the use of FLDM. It is known that FLDM can write waveguides suitable for light propagation in a number of dielectric materials without significant collateral damage. For example, PCT Application No. WO 02/16070 of Bourne et al. published on Feb. 28, 2002, which is incorporated herein by reference, describes methods to produce waveguides which can operate at λ=1.5 μm.

With the inherent precision of FLDM, it is no longer necessary to manipulate optical components physically with micron precision. Instead, they can be brought to abut a common block of dielectric with no great precision and then connected by writing a waveguide between them using FLDM, without a need to physically manipulate the components to achieve proper alignment. The FLDM laser focus is located with reference to the output/inputs of the components to be connected. This process can be accomplished using optical techniques and is open to automation.

Waveguides are made in bulk dielectrics using FLDM by moving the focus of the laser, to which the modification of the refractive index is restricted, within the workpiece. The motion can be controlled using computer-linked nanopositioners with high precision and the position of the focus in the workpiece can be accurately tracked once the initial position is defined. Linear waveguides can be written both longitudinally by translating the workpiece along the laser beam axis, and transversely by moving normal to the laser beam. A combination of both transverse and longitudinal writing and/or writing from two orthogonal directions, as discussed below, is typically used for three-dimensional (3-D) structures. The size of the waveguide is adjusted by modifying the size of the focus, within restraints imposed by self-focussing as described, for example, in the above-identified PCT Application No. WO 02/16070, and by rastering the focus to make larger features.

The use of FLDM permits precise alignment of an FLDM-written waveguide to the input and output devices, or to other desired locations. FLDM can also provide sufficiently bent waveguides for cross-connects and for accommodating designs that require connections between components on orthogonal faces. FLDM also permits waveguides to be written right up to the edges of the block, where input and output devices are attached, without damaging the components or the interface.

In an embodiment of the present invention, the optical properties of the external optical elements are used to define their positions and to precisely locate the connection points on the surface of a bulk dielectric block. The FLDM beam delivery optics are used in reverse to image light supplied by or delivered through the external optical component to accurately locate the connecting waveguide to be written in the dielectric block. The method of fabrication of the present invention uses many of the concepts proposed in PCT Application No. WO 01/54853 to Corkum et al., published on Aug. 2, 2001, which is incorporated herein by reference. Corkum et al. discloses femtosecond laser repair of micro-defects in quantum well infrared detectors directed by imaging light emitted from the defect using the same optical system used to deliver the laser.

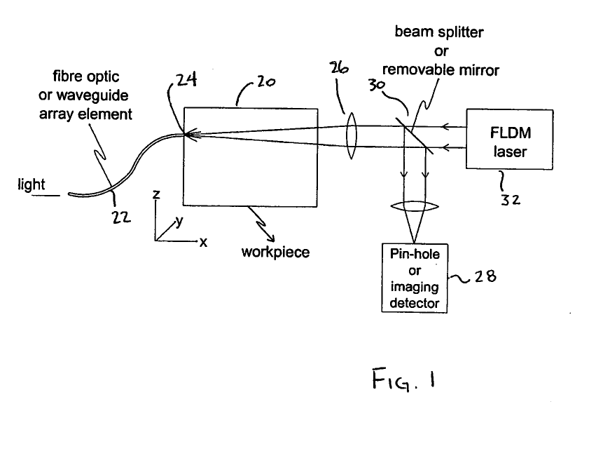

An exemplary apparatus, suitable for longitudinal writing of a waveguide in a bulk dielectric block workpiece 20 and using a fiber as an example of the external optical component 22, is depicted in FIG. 1. With reference to FIG. 1, y and z positions of the connection face 24 where the external optical component 22 is attached to, or abuts, the workpiece 20, are found by moving the workpiece 20 relative to the beam delivery optics 26, or vice versa, to maximize the brightness of the image of the light emitted by the external element 22 at an imaging detector 28. The light is provided by an external source (not shown) connected to the external optical component. A beam splitter or removable mirror 30 can be used to reflect the image to the imaging detector 28. The x position is found by bringing this image into focus on the detector 28, the imaging system having been previously set up to image the laser focus from the FLDM laser 32. This can be achieved by imaging the normal reflection from a planar surface placed at the laser focus prior to introducing the workpiece 20. To write a waveguide from the connection point 24, the FLDM laser power is activated and the workpiece 20 translated to make a connecting waveguide longitudinally through the workpiece to provide an optical connector. A further external optical component can then be attached to the opposite end of the waveguide.

This apparatus of FIG. 1 is particularly appropriate for connecting fibers, waveguides, diode lasers and other optical elements. To align to a diode, the diode itself can act as the light source. Although depicted for a single fiber, the apparatus of FIG. 1 is also appropriate for any locating any component in an array of components. In FIG. 1, the focussing optics 26 are depicted as simple lenses. The basic idea can be applied to more complex beam delivery arrangements and those using reflective optics.

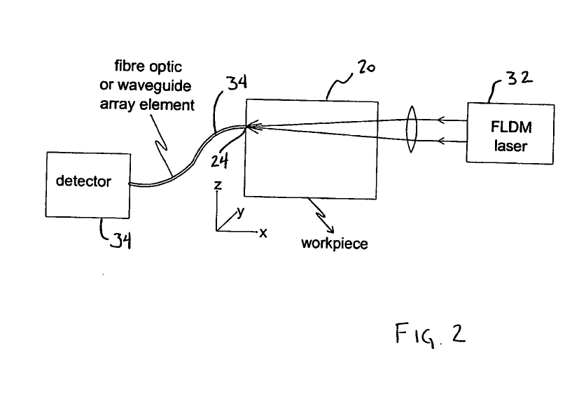

A variation of the apparatus of FIG. 1, particularly applicable for fibers, waveguides and other transmissive components, is shown in FIG. 2. In the arrangement of FIG. 2, light from the FLDM laser 32, operated at low power, below the FLDM threshold, is collected by the transmissive optical component 34 at the point or face 24 where it is attached to the workpiece 20. Coupling is optimized when the relative position of the workpiece 20 and laser focus is adjusted to maximize the signal registered by a detector 36. When maximum coupling is achieved, the FLDM laser focus is located at the point of coupling with the external optical component 34. To write a waveguide from this point the FLDM laser power is turned up and the workpiece translated with respect to the FLDM laser focus to write a connecting waveguide within the workpiece 20, thus providing an optical connector according to the present invention.

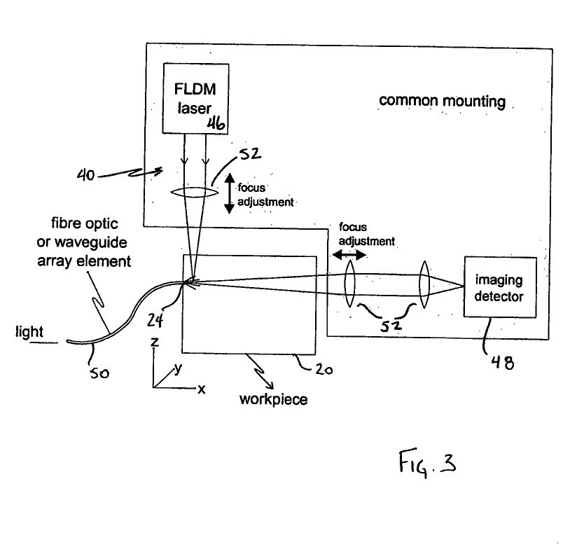

For writing waveguides in the transverse mode, a different approach can used involving two imaging systems 40 and 42, usually orthogonal, as shown in FIG. 3. The two orthogonal optical systems are co-aligned to a common focus in the workpiece 20. A way of achieving this co-alignment is to image the light emitted from optical breakdown caused by the FLDM laser 46 through the other system 42, which includes an imaging detector 48. The external component interface point 24, where the external optical component 50 is abutted to the workpiece 20, is then located using the imaging system 42 orthogonal to the FLDM arm using the procedure outlined above. Because the relation of the FLDM focus to the imaging system focus is previously determined, the FLDM focus can then be positioned anywhere with respect to the external optic to write a waveguide in the dielectric block to provide the desired connection path. Focus adjustment can be provided by adjusting the position of the beam delivery optics 52.

Writing from two orthogonal directions is complicated due to the dielectric block workpiece 20 having a refractive index greater than its surroundings. With the focus inside the workpiece 20, the effective focal length of each beam delivery lens 52 is dependent on the distance of the lens from the workpiece. If the foci are co-aligned in air to calibrate their relative positions, correction will have to be applied depending on the distance between the surface of the workpiece 20 and the focus. This distance can be known with sufficient accuracy if the dimensions and position of the block are pre-determined or measured in situ.

An algorithm to compensate for the position dependence of the focal length can be based on standard optical formulae. It is also possible to co-align the foci by observing FLDM laser-induced breakdown in the workpiece 20 itself by operating the FLDM laser 46 at high power. This can be done at some location where damage is not important. The correction will then be small if the alignment is made close to where the waveguide is to be written. An alternative technical solution is to immerse the workpiece in index matching fluid.

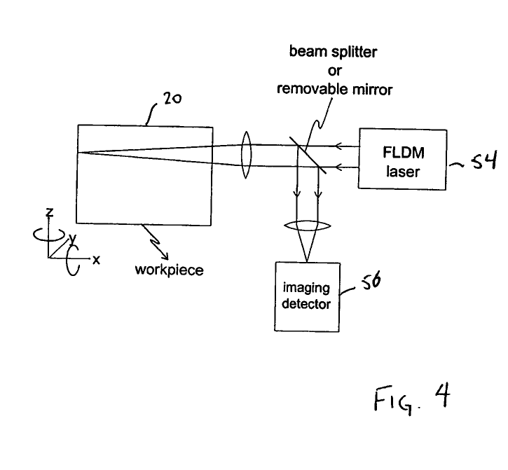

Certain applications do not require writing connection paths to pre-connected components. For instance it is effective, in certain cases, to write connecting waveguides in a block so that their inputs and outputs match precisely the known configurations of external arrays (e.g. photodiodes or diode lasers). A single physical alignment step can then be used to align the whole array. In this case, where there is no external component to which to directly align, the workpiece 20 can be located precisely with respect to the laser focus by operating the FLDM laser 54 at low power, below the FLDM threshold, and observing the light reflected from surfaces of the workpiece block 20, as depicted in FIG. 4. The optical system is set up so that when the laser focus is at a surface of the workpiece 20 its reflection is in focus at a detector 56. If the dimensions of the block 20 are known, and the block faces are orthogonal and parallel, measurements from three orthogonal surfaces locate the block precisely. Rotational motion of the workpiece 20 is required for this procedure in addition to x,y,z, translation. If the dimensions are not known, measurements from further surfaces can be made until the position and shape of the block are determined.

There is also a difficulty in writing a waveguide right to the end of a dielectric block where waveguide arrays may be butted and epoxied. The laser damage thresholds at the glass/air interface or the glass/epoxy interface are much lower than that of the bulk material and damage can occur at these surfaces. To avoid damage at the interface, the waveguides can be written as close to the interface as possible without causing damage. This leaves a short free propagation space between the external component and the internal waveguide. However, for many applications such losses may be acceptable.

Alternately, the position of the external optical component in the butted position can first be accurately located with an imaging system, as described above, and can the external component can then be pulled back, in the range of 50 μm, until the laser has written the desired internal waveguides. The external component can then be moved back into position for permanent connection. Index matching fluids or the use of a temporary bonded dielectric layer can be used to prevent damage to the glass block as outlined, for example, in Bourne et al.

Another method of avoiding damage at the interface uses a precision dimension block. All the external components in an array are located relative to reference positions on the block. Waveguides can then be written in the block to the recorded positions with the external components completely removed. Replacing them requires a single physical alignment. If surface damage occurs this approach also gives the option of polishing any damaged regions.

Where coupling conditions permit, the waveguides forming the connection paths can be reverse tapered to increase in diameter as they approach a surface of the block. A wider waveguide requires a lower change in refractive index, which can be achieved with lower laser dosage, decreasing the extent of surface damage.

A particular advantage of the present invention is the ability to write connection paths with bends directly into a dielectric block. The volume element modified by FLDM without motion of the workpiece is determined by the focal parameters and non-linear absorption as described, for example, in Bourne et al. Using spherical optics the active volume is relatively long and thin and can be quite small, typically a 15 μm×2 μm ellipsoid for f3.6 optics. Bourne et al., for example, describes strategies for writing waveguides with circular cross-sections despite this asymmetry. These strategies include rastering, writing longitudinally and use of combined cylindrical/spherical optics to tailor the laser focus. Connectors of the type described herein can require waveguides bent as much as 90° or more. Writing such bent connecting waveguides with a long thin activated volume can be met by several complementary strategies.

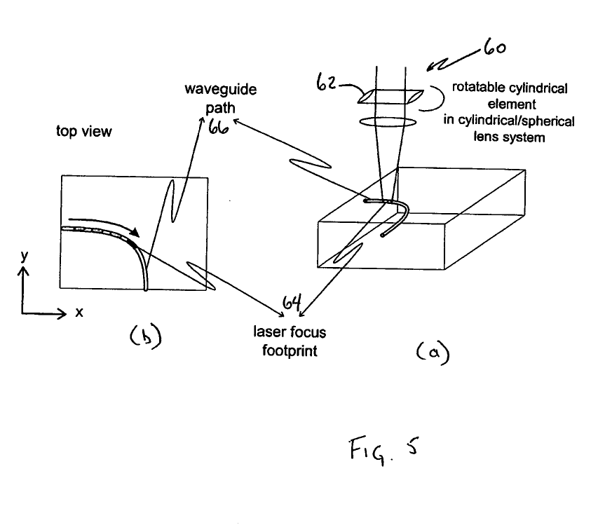

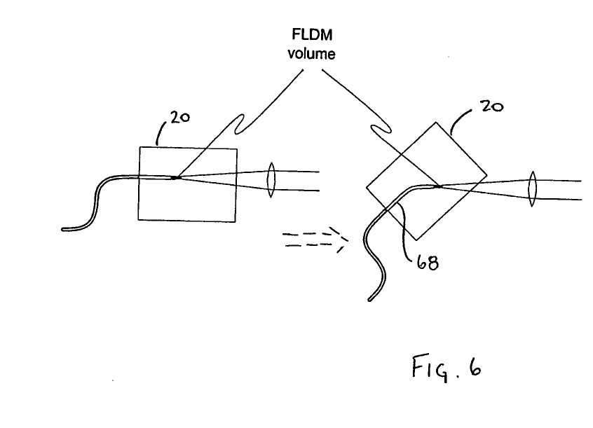

One such strategy, using cylindrical/spherical beam delivery optics 60, such as described in Bourne et al., and adjusting the cylindrical element 62 during writing to rotate the laser footprint 64 to keep it tangential to the resulting connecting waveguide 66, is shown in FIG. 5a. FIG. 5b shows a top view of the workpiece 20 with the resulting waveguide 66. A second strategy for producing a bent waveguide 68 in a workpiece 20 involves writing the waveguide longitudinally while rotating the workpiece 20, as shown in FIG. 6.

Another method and apparatus for writing a bent waveguide connector uses high f optics to reduce the length of the active volume to below the waveguide dimensions and write the waveguide from one side, starting in the longitudinal mode and moving to the translational mode, or vice versa. Rastering a small active volume compared to the dimensions of the waveguide allows the refractive index profile of the waveguide to be tailored by controlling the exposure. Asymmetric profiles are achievable and, in particular, it is possible to deepen the refractive index change on the inside of waveguide bends to reduce losses and thereby decrease the radius of the bends.

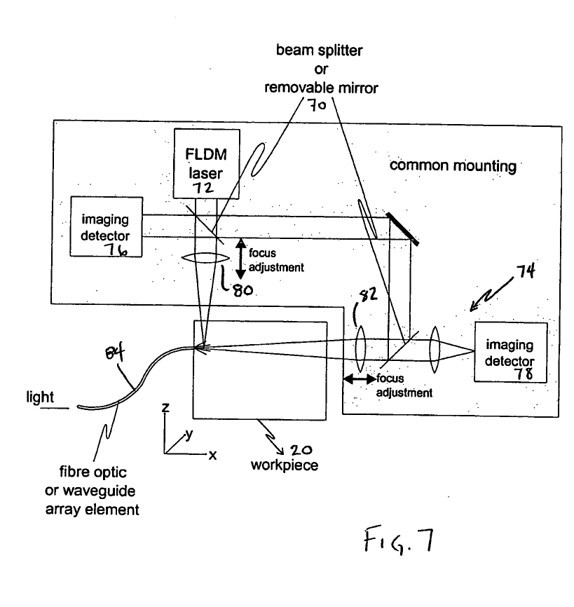

Similarly, high f optics can be used to reduce the length of the active volume to below the waveguide dimensions and write the waveguide from two orthogonal sides, either longitudinally or transversely, as suits best to obtain the specified waveguide profile, again using rastering to define the waveguide dimensions. This can be achieved using a variation of the optical arrangement shown in FIG. 3. Beam splitters and/or removable mirrors 70 are used to exchange the laser delivery 72 and imaging arms 74 of the system, as depicted in FIG. 7, and allow laser beam delivery from either direction, or even both directions, while still knowing the position of the foci. Image detectors 76 and 78, in conjunction with adjustable beam delivery optics 80 and 82, permit accurate positioning and locating of the beams. The arrangement of FIG. 7 is especially useful in writing waveguides connecting an external component 84 to an external component situated on an orthogonal surface of the block 20, as swapping the imaging and laser delivery arms allows both optical components to be located with precision.

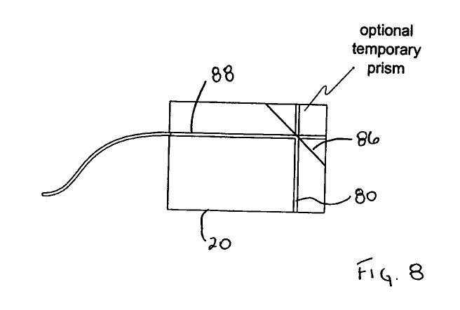

Another method of bending light within the workpiece 20 is shown in FIG. 8. Internal reflections at a surface 86 can be used to transfer light between angled linear waveguides 88 and 90. In order to avoid surface damage problems at the 90° bend, a temporary bond can be made to a prism so that the waveguides 88 and 90 can be written all the way through the interface. Alternatively, the waveguides 88 and 90 can be written to cross just below the angled surface 86 that can be polished down subsequently. The use of total internal reflection in a prism, that essentially acts like a turning mirror, results in a considerably lower effective bend radius. This not only allows compact connectors to be made but also reduces the optical path length of the FLDM written waveguides. The short length of the waveguides (<1 cm) can result in a reasonable overall connector loss despite the waveguide loss per cm potentially being considered too high for telecom applications (e.g. >0.2 dB/cm).

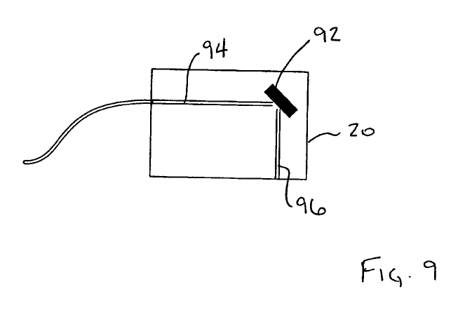

Rather than relying on total internal reflection to provide a tight bend, photonic crystal structures 92 can be used to assist in guiding light around tight bends and linking two waveguides 94 and 96 written in the workpiece 20, as shown in FIG. 9. These structures 92 can be written by a combination of FLDM and chemical etching as described, for example, in U.S. Publication No. 2003/0235385 to Taylor et al. published Dec. 25, 2003, which is incorporated herein by reference.

The methods and connectors of the present invention can be used in any number of configurations. For example, straight through connections can be made in a block of dielectric to reference waveguide locations. As described above, techniques for forming straight through connections require clear line of sight through the opposite face. Straight through connections cannot be made if both the input and output external arrays are in position. To overcome this limitation, an array of external input components can be placed in contact but not attached to a block face. The location of the array is then referenced with respect to the block face. Optical procedures described above can be used to locate individual waveguides and record their position relative to reference positions on the precision block face. A set of output components can then be butted to the opposite face of the block where the locations of all the output guides can be obtained, again referenced to the precise dimensions of the block. Precision rotation of the block through 1800 keeps the previous reference positions known. Waveguide connectors can then be written in the block according to the recorded locations of the external waveguides. In principle the block can be polished to remove any surface damage; then, the external guides can once again be brought into contact with the appropriate faces of the block, aligned and glued into position.

In a variation of the straight through configuration, optical conditioning elements can be inserted between waveguide arrays or demountable connections can be made between arrays. The block, with the straight through written waveguides, is cut in half at right angles to the written waveguides and polished on its two inside surfaces. The external arrays are then connected to the outside halves of the block and a gap is left between the blocks to insert an optical element such as a filter. This configuration is important since its function, whereby light delivered from one fiber passes through an optical element where it is modified then collected by another fiber, is a common requirement in telecom photonics. This requirement is currently met using discrete components assembled from fibers, where thermally expanded core technology is used to create fiber tapers that permit greater light collimation through the optical element. Using the connector of the present invention, raster scanning or focal spot modification can be used on-the-fly to control the waveguides diameters to adiabatically expand them to produce a collimated beam through the optical element where it can be received by a similar expanded waveguide in the second block which then connects to an external waveguide. If the intermediate element is left out and mechanical provision is made to bring the two parts together with repeatable precision a demountable array connector results.

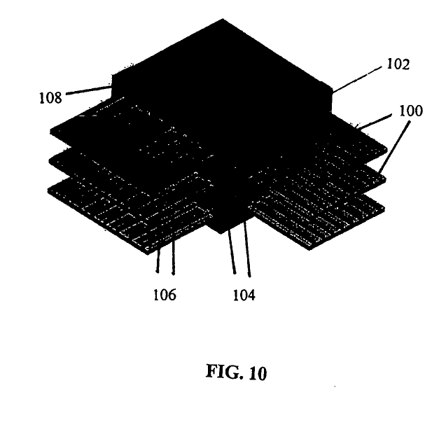

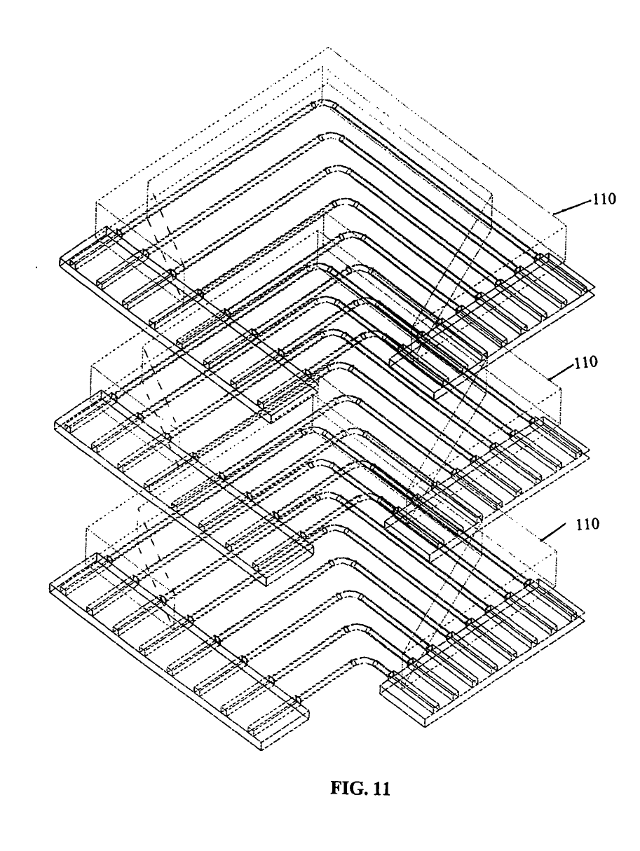

A further configuration permits optical connection of attached waveguide arrays to attached waveguide arrays in a single block of dielectric. In this configuration, shown in FIG. 10, arrays of optical components 100 are attached to one block face 102 and connected by internal waveguides 104 to other arrays 106 on an orthogonal block face 108. The arrays are attached to orthogonal faces since it would be very difficult for the imaging system to locate the guides if they were on opposing faces and be able to deliver femtosecond laser light to connect them without the attached guides blocking the laser beam. Methods for writing such bent waveguides 104 are given above. FLDM writing of waveguides is not restricted to blocks of dielectric material but can include other geometries such as slabs 110 which can be stacked as shown in FIG. 11.

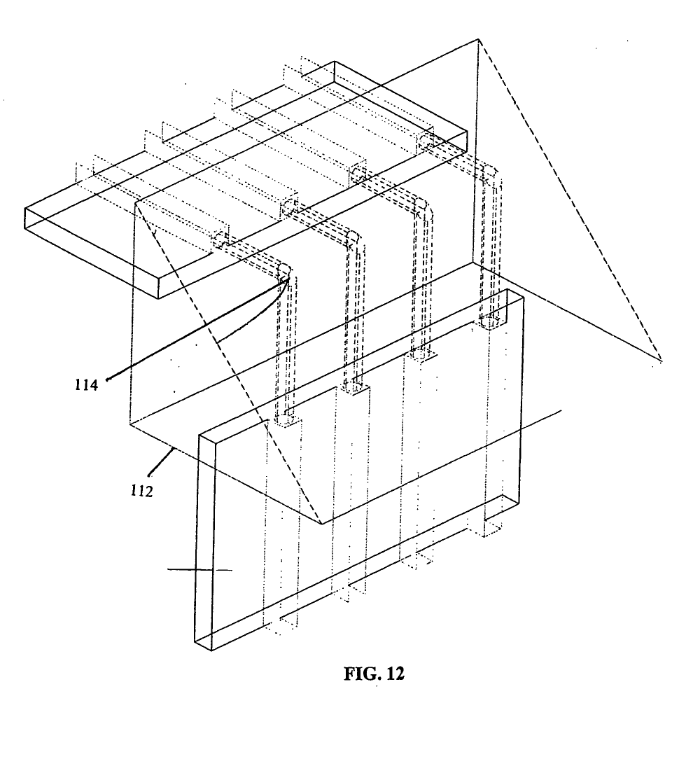

A variation of the bent waveguide configuration uses a prism 112 instead of a block as shown in FIG. 12. The prism angle is chosen to provide efficient total internal reflection of the guided light to form a bend 114 of about 90°. In order to avoid surface damage problems at the 90° bend, it can be advantageous to make a temporary bond between two prisms and write the waveguides all the way through the interface of the prisms.

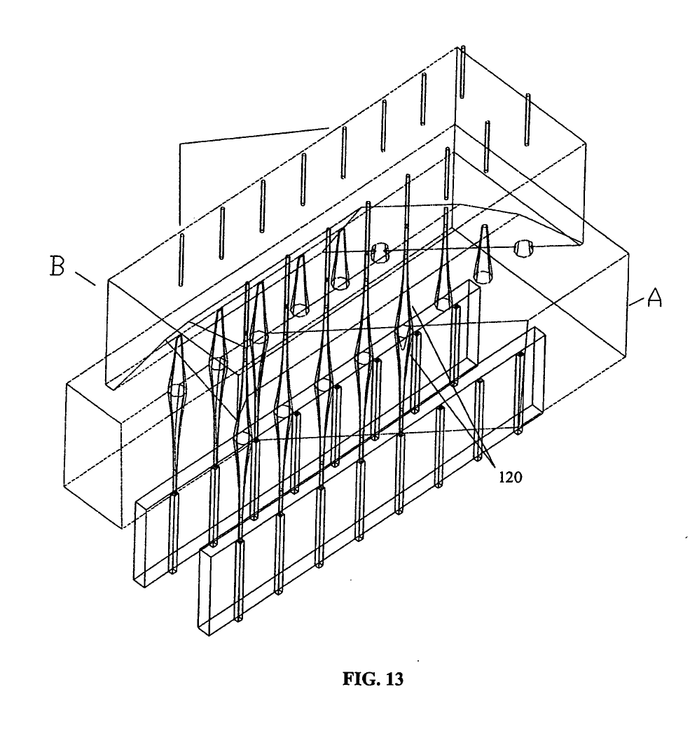

To provide a connection of attached waveguide arrays to attached waveguide arrays using two precision dimensioned blocks of dielectric 116 and 118, the configuration of FIG. 13 can be used. Waveguide, fiber or diode laser arrays can be attached to one face of each block. Femtosecond laser written waveguides 120 are fabricated from each external guide to a predetermined (i.e. referenced) location on the opposite face of each block. The reference locations can be determined using the sharp edges of the block faces together with the precise dimensions of the block. The blocks are then aligned and joined to produce array to array optical connection. This approach does not require the use of bent waveguides or the need for two focussing systems. The waveguides can be expanded at the block/block interface to allow for alignment inaccuracies between the two block faces.

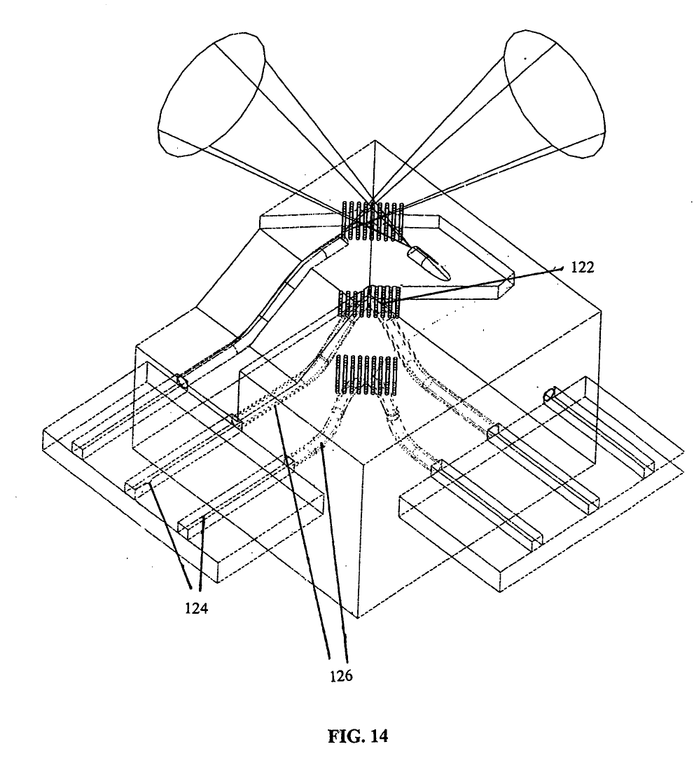

FIG. 14 shows a configuration using photonic crystal structures to assist in guiding light around tight bends. This example demonstrates how photonic crystal structures 122 can be used to assist light guiding around tight bends in the plane of an accessible surface. After the photonic crystal structures 122 have been etched, external components 124 can be attached to the blocks and internal waveguides 126 can be written from them (as shown in FIG. 10) to just enter the photonic crystal bend zone, thereby completing the optical connection. Multiple photonic crystal arrays can be written on the top of the block to provide complicated bending and light redirection functions. The use of photonic crystal technology to dispense with large 4 mm radius bends can shrink the size of the optical connector significantly, and also lowers the connector loss.

Increased value can be achieved by incorporating components such as splitters, couplers, mode converters, adiabatic tapers etc. into the block dielectric connector, along with the basic waveguides for optical connection.

A further application of the optical connectors and connection method of the present invention using FLDM, permits any number of waveguides to be written internally in connection blocks. Such waveguides can be pre-fabricated by prior FLDM or other microfabrication techniques. In this manner, the optical equivalent of an Application Specific Integrated Circuit (ASIC) used in electronics, where customized (application specific) function is realized by making or breaking links between arrays of standard components provided on the mass-produced ASIC chip, can be provided. In the optical ASIC, as is provided according to an embodiment of the present invention, FLDM is used to make the connections between pre-existing optical components on a chip. In this respect, the optical ASIC is an inverse analogue of electronic ASICs where current is directed by removing links. Connecting the components involves selectively writing waveguides within the provided dielectric connecting blocks, or writing couplers to connect the pre-existing waveguides to the desired components. As in its electronic counterpart, the optical ASIC can be generic and produced with high volume economy.

The present invention, in its various embodiments can provide a number of advantages and/or novel features. It permits the use of a single dielectric block with directly written waveguides to connect optical components together with sub-micron precision. The invention permits the application of FLDM to make these optical interconnects. The use of two coupled orthogonal optical systems permits location of the waveguides as well as delivery of the femtosecond laser radiation to write the internal waveguides to connect external arrays of attached waveguides. The use of optical techniques takes advantage of the optical properties of the components to be connected, to direct FLDM waveguide fabrication with the precision necessary to make low-loss connectors. The invention also permits the creation of a 3-D optical ASIC using FLDM as an enabling technology for its realization. Precise control, with respect to spatial and depth of refractive change, afforded by FLDM permits waveguide profiles to be tailored, thereby improving propagation of light through bent waveguides. The invention also permits the use of two precision dimension blocks to permit optical wiring between arrays of waveguides permanently attached to opposing block faces. The invention also permits the use of total internal reflection from the inside face of a prism as a means of guiding light around a 90° bend and making a compact connector.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. An optical connector for connecting an input optical component to an output optical component, comprising:
a three-dimensional optically-transmissive bulk dielectric for abutment with an input connection face of the input optical component and an output connection face of the output optical component; and
a connection path written within the three-dimensional bulk dielectric for connecting the input connection face to the output connection face.

2. The optical connector of claim 1, wherein the three-dimensional bulk dielectric is a glass block.

3. The optical connector of claim 1, wherein the three-dimensional bulk dielectric is a prism.

4. The optical connector of claim 1, wherein the connection path is a waveguide.

5. The optical connector of claim 4, wherein the waveguide is formed by localized modification of the refractive index of the bulk dielectric.

6. The optical connector of claim 4, wherein the waveguide is profiled to minimize transmission losses at the input and output connection faces.

7. The optical connector of claim 1, wherein the connection path is a straight through path.

8. The optical connector of claim 1, wherein the connection path is a bent.

9. The optical connector of claim 8, wherein the bent connection path is a bent waveguide.

10. The optical connector of claim 9, wherein bent waveguide is profiled to minimize transmission losses at a bend.

11. The optical connector of claim 8, wherein the bent connection path includes two substantially orthogonal waveguides disposed within the bulk dielectric to permit total internal reflection from one of the two waveguides to the other.

12. The optical connector of claim 11, wherein the two waveguides intersect at a polished surface of the bulk dielectric.

13. The optical connector of claim 8, wherein the bent connection path includes two substantially orthogonal waveguides interconnected by a photonic crystal structure.

14. The optical connector of claim 1, having a plurality of connection paths written within the bulk dielectric for connecting an array of discrete input optical components to an array of discrete output optical components.

15. A stacked optical connector assembly, comprising a plurality of optical connectors according to claim 14 stacked to form the connector assembly.

16. A method of manufacturing an optical connector for connecting a first optical component to a second optical component, comprising steps of:
locating a first optical connection point, for connection to the first optical component, on a first surface of a three-dimensional optically-transmissive bulk dielectric workpiece;
writing a connection path within the workpiece from the first optical component connection point to a second optical component connection point, for connection to the second optical component, on a second surface of the workpiece.

17. The method of claim 16, wherein the step of locating includes imaging the first optical connection point at an imaging detector.

18. The method of claim 17, wherein the step of locating includes detecting an image of maximum brightness and focus at the imaging detector.

19. The method of claim 16, wherein step of writing includes selectively modifying the refractive index of the workpiece.

20. The method of claim 16, wherein the step of writing includes translating the workpiece relative to a writing means.

21. The method of claim 16, wherein the step of writing includes femtosecond laser dielectric modification.

22. The method of claim 16, wherein the steps of locating and writing are repeated to provide connection paths between a plurality of discrete optical components in first and second optical component arrays.

23. An apparatus for manufacturing an optical connector for connecting a first optical component to a second optical component, comprising:
means for locating a first optical connection point, for connection to the first optical component, on a surface of a three-dimensional optically-transmissive bulk dielectric workpiece;
a laser system for modifying the workpiece in three-dimensions to provide an optical connection path within the workpiece for connecting the first optical connection point to a second optical connection point, for connection to the second optical component, on a second surface of the workpiece.

24. The apparatus of claim 23, wherein the means for locating includes an imaging system for detecting an image of the first optical connection point.

25. The apparatus of claim 23, wherein the laser system is a femtosecond laser dielectric modification system.

26. The apparatus of claim 25, including two orthogonal imaging systems for writing the connection path in a transverse mode.

27. A customizable optical circuit, comprising:
a plurality of optical components mounted on a wafer; and
a plurality of selectively activatable connection paths for selectively connecting the optical components to provide a customized optical function.

28. The customizable optical circuit of claim 27, wherein the plurality of selectively activatable connection paths are written within three-dimensional optically-transmissive bulk dielectric blocks abutting connection faces of the plurality of optical components.
